(19) United States
(12) Patent Application Publication
(10) Pub. No.: US 2003/0167329 A1
(43) Pub. Date: Sep. 4, 2003

(54) Communication system and method for locating and utilizing distributed resources

(75) Inventors: Shoji Kurakake, San Francisco, CA (US); William Alexander Hagen, Montara, CA (US)

Correspondence Address: Tadashi Horie, Brinks Hofer Gilson & Lione, P.O. Box 10395, Chicago, IL, 60610, US

(73) Assignee: DoCoMo Communications Laboratories USA, Inc.

(21) Appl. No.: 10/087,337

(22) Filed: Mar. 1, 2002

(51) Int. Cl. G06F 15/173; G06F 9/00

(52) U.S. Cl. 709/226; 709/105

(57) ABSTRACT

A communication system includes one or more independent communication networks. Each network includes one or more resource management devices, resources managed by the resource management device, and one or more resource arbitration servers. The communication system further includes a communication device adapted for communication on each of the one or more communication networks.

### BACKGROUND

The present invention relates generally to data communication networks. More particularly, the present invention relates to a communication system and method for locating and utilizing distributed resources in wireless or wireline networks.

Communication systems provide access to remotely located resources. Resources are all equipment and facilities that provide services desired by a user in the system. For example, in a wireline local area network (LAN), the services of data storage and document printing might require resources of network interconnections, the user's personal computer, a disk drive and associated data storage server, and a network printer. In another example, a wireless voice communication network providing services of directory assistance for a subscriber includes as resources the subscriber's radio handset, the base station and wireline connection to a switching center, wireline connection to a centralized name and number database and the computing system implementing the database.

When a single entity controls all resources in the system or the presence of such resources changes little over time, the resources are defined and known to other resources in the system. This is the case in a mobile access network in which the subscriber pays for a service from the service provider, using the service provider's mobile station to access the service provider's mobile access network and in turn access the service provider's core network and the service provider's gateway to the internet. By using control signaling within the network, the subscriber and the mobile station used by the subscriber can be readily informed of the availability of resources in the system. This can even by done in the background so that availability or unavailability of resources is completely transparent to the subscriber.

In the future, however, it may be desired to provide a greater variety of services and to provide them more flexibly. This means that services will be provided not by predefined resources, but by any available resources. Examples of such resources to be implemented include third and fourth generation mobile wireless networks, wireless LAN and wireless local loop, video and audio coding and decoding equipment, computing servers, proxy serves, disk servers and others. Such resources are not necessarily owned by one service provider but may be owned by different resource provider and be available for all users or subscribers.

In another example, a future virtual mobile operator (VMO) will offer mobile services to subscribers and manage their accounts and may even operate its own mobile switching center but will not have its own radio frequency spectrum. Rather, a VMO will collaborate with one or more mobile service operators which do own spectrum for resale. The VMO will need to be able to rapidly determine what kinds of resources are available and what service provider can provide them, both wirelessly and over a wireline network, depending on time of availability, schedule, cost, technical capabilities, etc.

In these systems, it will be necessary to identify and locate available resources to enable the envisioned flexible service realization. Preferably, location and utilization of such resources may be done on an on-demand basis, that is, available and provided at the time the user needs the resources without further intervention.

In earlier solutions, industry consortia or other groups establish standards for communication among office equipment. The Salutation Consortium allows cooperation among makers of computers, printers and other office equipment. The Bluetooth Special Interest Group and the Jini organization have tried to create ways to set up networks on the fly. Bluetooth is a specification which establishes a radio connection between two Bluetooth-enabled devices. Once a connection is established, Bluetooth defines a service discovery protocol which helps the computer devices set up a network on the fly. The Jini protocol allows a device to set up a network with another device, such as a printer. Jini does not specify how a computer and the printer are connected to the network, but specifies how the two devices should negotiate services, etc. Jini also provides a discovery protocol which, is, however, incompatible with that of Bluetooth.

The Salutation protocol also includes a discovery protocol. A device in a Salutation system uses the Salutation discovery protocol to ask other devices on its network about their capabilities. The inquiry passes from the Salutation manager to a transport manager which prepared the inquiry to run over the network transport protocol of the network. The inquiry is sent to a destination such as a server, which supplies the requested information. Then a communication between the device and the server is established.

However, this previous protocol only accommodates network appliances such as computers, printers and the like. In future applications, resources can be anything including the right to use movie contents, office space that hosts disk servers, home appliances which are not always connected to a network but can be temporarily connected by Bluetooth, for example, and so forth.

Accordingly, there is a need for a system and method which permits resource location and utilization even for resources which are not network appliances.

### BRIEF SUMMARY

By way of introduction only, the present embodiments provide a communication system including one or more independent access networks, and one or more independent or mutually connected core networks. Each core network includes one or more resource management devices, resources managed by the resource management device, and one or more resource arbitration servers. The communication system further includes a communication device adapted for communication on each of the one or more access networks.

The foregoing discussion of the preferred embodiments has been provided only by way of introduction. Nothing in this section should be taken as a limitation on the following claims, which define the scope of the invention.

### BRIEF DESCRIPTION OF SEVERAL VIEWS OF THE DRAWINGS

FIG. 1 is a block diagram of a communication system;

FIG. 2 is an operational block diagram of a communication device for use in the communication system of FIG. 1;

FIG. 3 is a block diagram of a resource arbitration server of the communication system of FIG. 1; and

FIG. 4 is a block diagram of a resource management device of the communication system of FIG. 1.

### DETAILED DESCRIPTION OF THE PRESENTLY PREFERRED EMBODIMENTS

The embodiments shown herein relate to a communication system capable of accepting from a variety of resource providers the resources required when performing communication tasks. These resources include communication equipment resources as well as resources other than equipment that may not be connected via a network. Examples of such resources include land and rights appurtenant to land, buildings, equipment not connected to a network such as an automobile or recreational equipment, and copyrighted material or otherwise licensable proprietary rights in tangible and intangible objects. The embodiments described herein disclose method and apparatus for accessing and exercising those resources with communication tasks.

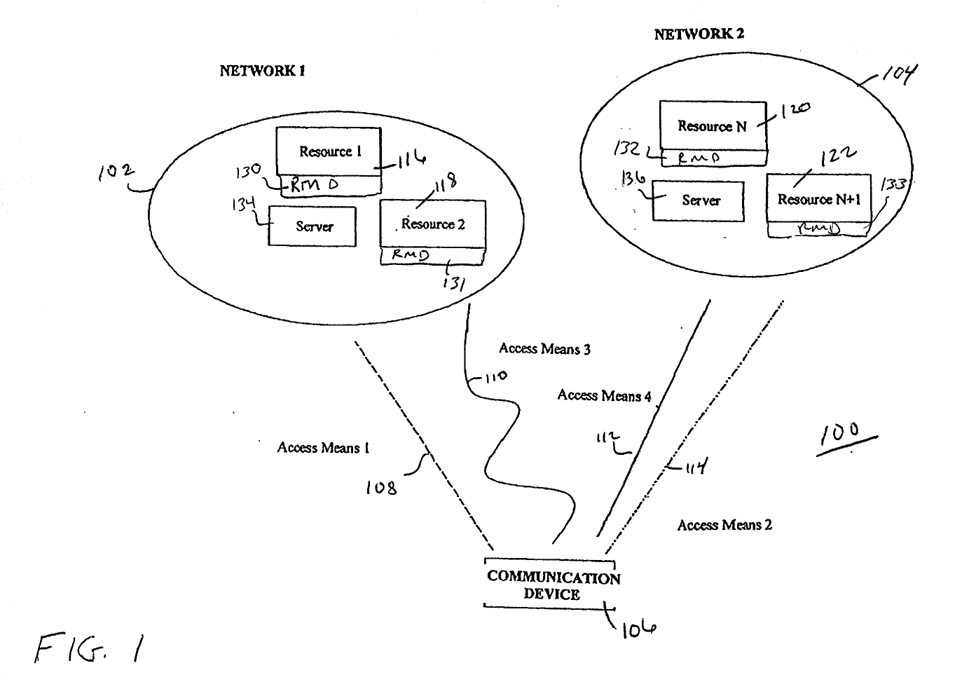

Referring now to the drawing, FIG. 1 shows a communication system 100. The communication system 100 includes a plurality of core networks including network 102 and network 104. The communication system 100 includes at least one communication device 106 which is adapted for communication with networks of the communication system 100. The communication device will be described in greater detail below in conjunction with FIG. 1.

The core networks such as networks 102, 104 are not directly interconnected. That is, there is no direct communication path between them and they are operated as independent networks. Each respective network 102, 104 may use a particular technology or combination of technologies. Each respective network 102, 104 may be configured for communication of data, data representative of voice or some combination of these. Thus, as an example, the network 102 may be a landline network using fiber optics, copper wire and local area network technology such as Ethernet to provide access between the communication device 106 and resources accessible by the network 102. Further in this example, an access network to the core network 104 may be a wireless network using satellite and cellular or point to point radio technology to provide access between the communication device and other resources accessible by the network 104. Other examples are possible, of course, and the scope of the embodiments and their equivalents should not be limited by these exemplary embodiments.

The equipment, including hardware and software, wireless and wireline, by which the communication device 106 accesses the networks 102, 104 forms an access network 108, 110, 112, 114 for accessing the core networks 102, 104, respectively and for accessing resources accessible by that network 102, 104. There may be multiple access means for accessing a particular core network from the communication device 106. For example, in the illustrated embodiment, the communication device 106 can access network 102 over a data cable 108 or over a wireless link 110. Further, the communication device 106 can access network 104 using a modem over a preexisting telephone system 112 or by radio link to a satellite data communication network forming the access means. Some of the access means may be available at all times and in all places.

Each network 102, 104 provides access to resources. For example, in the illustrated embodiment, the network 102 provides access to a first resource 116 and a second resource 118. The second network 104 provides access to an Nth resource 120 and a resource N+1 122. The number and types of resources accessible through any network are not limited in number and nature. As noted above, these may include network appliances such as data storage, a printer and a processor. Further, though, these resources may be other tangible items such as software applications or data files, non-data processing equipment such as construction equipment and farm implements, and intangible resources such as intellectual property rights and licenses or financial assets.

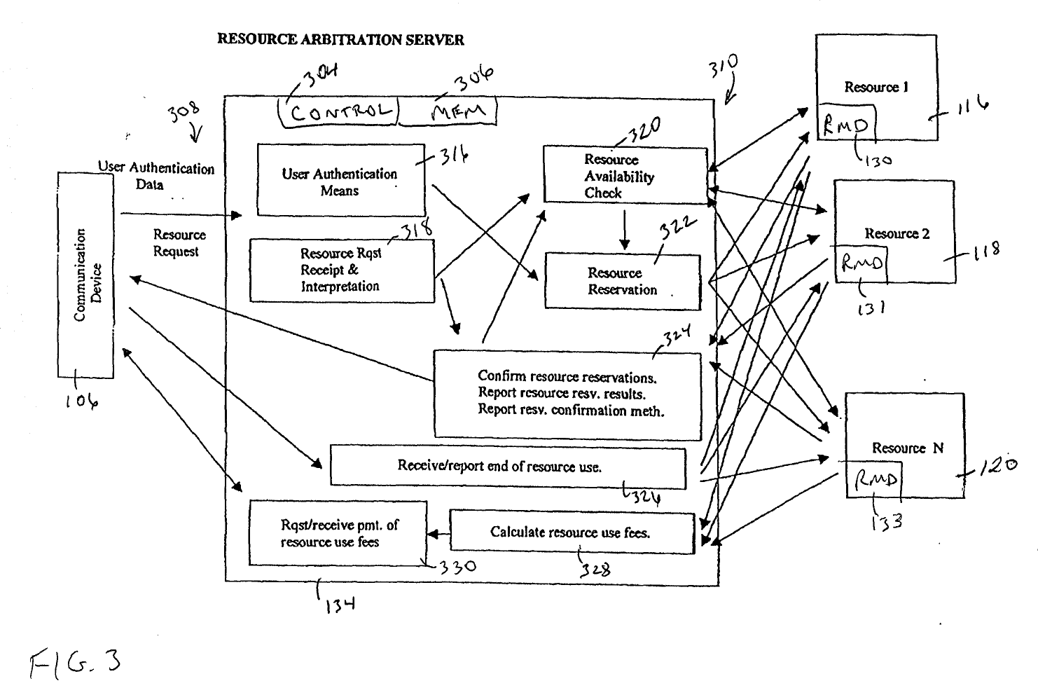

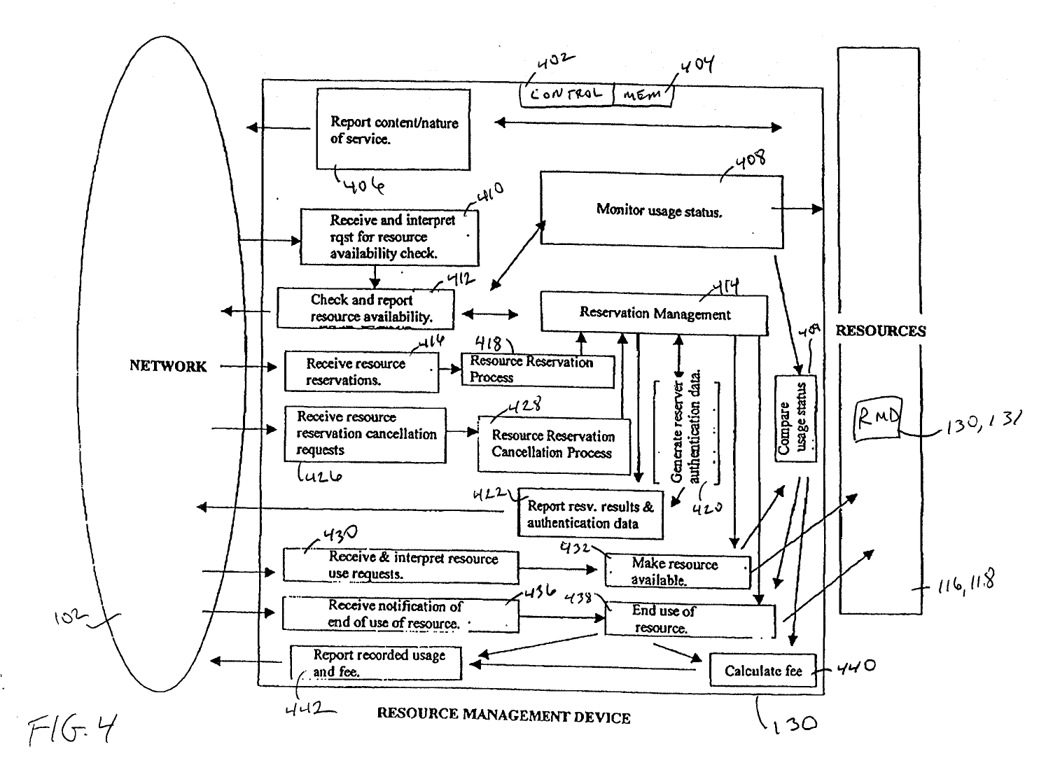

Associated with each resource 116, 118, 120, 122 is one or more resource management device 130, 131, 132, 133, respectively, and one or more resource arbitration servers, 134, 136, respectively. Each resource in FIG. 1 is preferably a combination of the resource itself and an associated resource management device for the resource. The resource arbitration server 134, 136 communicates with resource management devices 130, 131 132, 133. A resource and its managing device can be implemented into one body. For example, a network printer has a CPU. The CPU acts as a controller of printing tasks for the printer, and has also the function of a managing device that communicates with a resource arbitration server. Structure and operation of the resource arbitration servers will be described in further detail below in conjunction with FIG. 3. Structure and operation of the resource management devices 130, 132 will be described in further detail below in conjunction with FIG. 4.

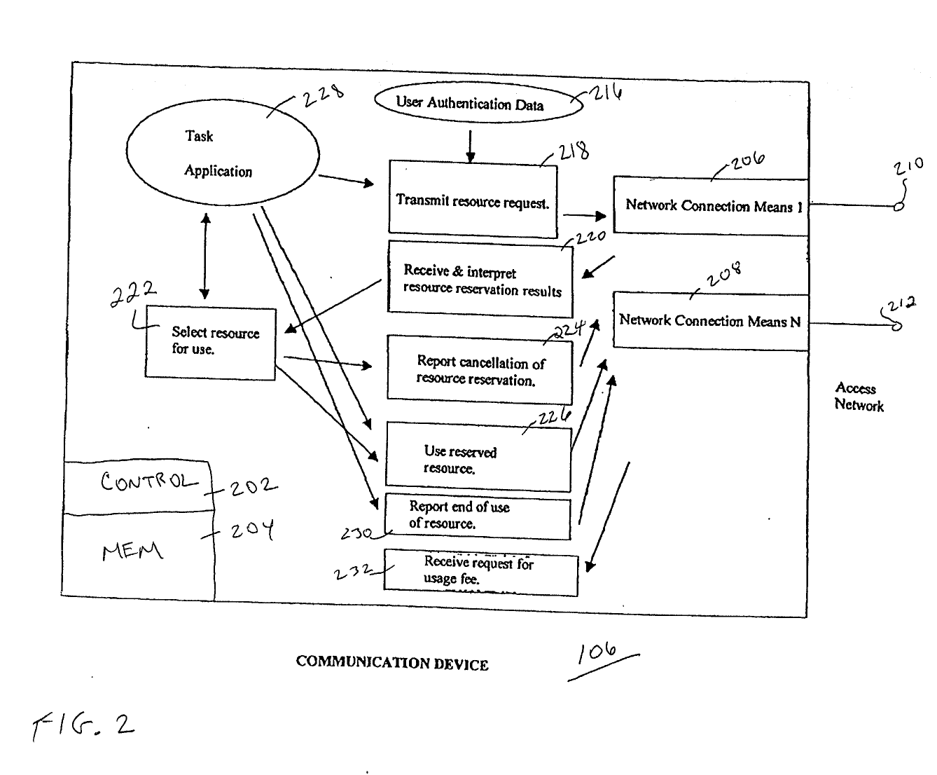

FIG. 2 shows an operational block diagram of a communication device 106 for use in the communication system of FIG. 1. The communication device 106 includes a control device 202, a memory 204, and a plurality of network connection means 206, 208 for connecting to one or more networks such as the networks 102, 104 of the exemplary communication system 100 illustrated in FIG. 1.

Exemplary embodiments of the communication device include a mobile or portable radio providing data and voice communication to a remote location; a fixed data terminal; a monitor which is associated with equipment which may or may not move and monitors some environmental, performance or other characteristic of the associated equipment, such as a device which monitors signals of the Global Positioning System and reports a geographic location of the associated equipment; a disk storage system which may actively access other data or processing resources on other networks as well as being accessed by such resources. These possible embodiments of the communication device 106 are exemplary only and should not be used to limit the scope of the embodiments described herein.

The control device 202 in one embodiment includes digital logic for implementing control functions for the communication device 106. For example, the control device 202 may include a microprocessor or microcontroller or digital signal processor. Such a processor operates in conjunction with data and instructions stored in the memory 204 to control other components of the communication device. In other embodiments, the control device 202 may include a user interface. Typical user interface elements include a display and keyboard or keypad as well as a microphone and speaker for audio processing. The network communication means 206 provide one-way or two-way communication with remote communication devices, such as the resources, resource management devices and resource arbitration server of the networks 102, 104 of FIG. 1. The first network communication means 206 provides communication by means of a first communication port 210. Similarly, the second network communication means 208 provides communication by means of a second communication port 212. The number of communication ports and network communication means included with the communication device 106 is arbitrary and may vary, as indicated by the subscript N on the second network communication means 208.

The network communication means 206, 208 are embodied in any suitable form for communication with the network and over the type of channel required. For example, if wireline communication over an Ethernet local area network is required, one of the network communication means 206, 208 may be embodied as an Ethernet card or other circuit which implements Ethernet send and receive functionality. Alternatively, if wireless communication is required, on of the network communication means 206, 208 may be embodied as a radio transceiver including operation at the necessary frequency bands and modulation/demodulation and encoding/decoding according to the specified standard.

The network communication means 206, 208 form a communication circuit. The communication may be software programmable under control of the control device 202. Data or other information received from a remote source by the network communication means 206, 208 is communicated to the appropriate destination within the communication device 106. Similarly, data or other information intended for communication to a remote destination is communicated first to a network communication means 206, 208 for formatting, encoding, etc., according to the appropriate communication channel. Thus, the network communication means 206, 208 may include a radio receiver and a radio transmitter for access to a wireless network or a network access card for access to a wireline network.

The remaining elements illustrated in FIG. 2 are show in functional or operational form. The functions implemented by these elements are shown in FIG. 2. These elements may be implemented as software routines executed by the control device 202 or by other logic circuitry of the communication device 104, by dedicated devices of the communication device 104, or by any other suitable means. For example, a user authentication device 216 stores user authentication information for authenticating the communication device or its user when accessing a network. In one embodiment, the user authentication device 216 includes user account data stored in memory such as the memory 204. In another embodiment, the user authentication device 216 includes a subscriber identity module or SIM card of the type used with wireless telephones on the GSM system. The elements of the communication device 106 may thus be embodied as any appropriate combination of hardware, software, mechanical devices or user interactions necessary to achieve the desired operational function.

A resource requesting device 218 generates and transmits a request for resources from a remote location accessible on a network. The request is conveyed to a network communication means 206, 208 which operates as a communication circuit for communicating a resource use request from the resource requesting device 218 to a resource arbitration server of a communication network (FIG. 1). The resource request may be submitted manually, by a user of the communication device 106, or may be generated by an application executing a task of the communication device 106. In some applications, or when requesting particular resources, the resource requesting device 218 transmit resource requests specifying a specific server or destination for the request or source of the requested resources on a network. Alternatively, the requests may be transmitted without specifying a specific server or destination or source. In this case, the request is broadcasted over the network and resource arbitration servers receive the request by recognizing the request is the resource request that the server can handle. For example, if the network includes the Internet, a request could be sent specifying the addressees or omitting the addressees.

An interpretation control circuit 220 is coupled with the communication circuit, network communication means 206, 208 and is configured to interpret reports of resource reservation results received by the network communication means 206, 208 from the resource arbitration server. In alternative embodiments, this operation may be performed by the control device 202 when suitably programmed. The circuit 220 further receives and interprets reservation confirmation methods provided by the resource arbitration server. A selection device 222 is configured to select resources for use or non-use based on a received report of resource reservation results. In response to the selection, report control circuit 224 is configured to notify the resource arbitration server or the resource management device (FIG. 1) to report cancellation of resources reservations for the resources that are not selected for use. Also in response to the selection, a task execution circuit 226 generates a resource reservation confirmation for communication to the resource arbitration server by the network communication means 206, 208 upon usage of the selected resources. The resources are actually used in a task application 228.

Following use of the resources, when a task is completed, an end of use reporting device 230 is configured to notify the resource arbitration server or the resource management device of the end of usage of the resources. In some applications or for some resources, a request of payment for usage fees for usage of the resources selected for use may be received by the network communication means 206, 208 from the resource arbitration server or the resource management device. Such a request is conveyed to a fee request device 232.

In a further alternative, the communication device 106 may arbitrarily select the access means to be used when communicating resource requests. For example, if wireless communication is available and the communication device 106 is a subscriber to wireless services, all requests for resources may be made using a wireless link to wireless infrastructure of the wireless service provider. However, if appropriate or desired, the communication device 106 may subsequently change to a different access means to communicate when executing tasks. In this example, after locating a resource over the wireless link, the communication device 106 may subsequently use wireline communication during execution of the task, such as reading a file attached to an E-mail message.

FIG. 3 is a block diagram of a resource arbitration server 134 for use in a network 102 of the communication system 100 of FIG. 1. The resource arbitration server 134 is shown in conjunction with the communication device 106 of the communication system 100 and with resources 116, 118 of the network 102.

The resource arbitration server 134 includes a control device 304 and a memory 306, a first communication interface 308 and a second communication interface 310. The control device controls operation of the resource arbitration server 134 and may include, for example, one or more processors operating in response to data and instructions stored in the memory 306 or received over one of the communication interfaces 308, 310.

The first communication interface 308 provides communication with the communication device 106. The second communication interface 310 provides communication with resource management devices 130, 131, 132 of the network. Communication on the communication interfaces 308, 310 may be according to any suitable communication protocol, wireline or wireless. For the second communication interface 310, communication may be in any of several different protocols, each communication tailored to the requirements of each particular resource and resource managing device for the resource.

The other elements of the resource arbitration server 134 are illustrated as operational or functional blocks. These functional blocks may be implemented as applications of the control device 304, as separate logical operations or as combinations of hardware and software.

The resource arbitration server 134 includes a user authentication device 316 which is configured to authenticate a user of the communication device 106 or the communication device 106 itself. Authentication is optional and need not occur for every transaction or every resource request. Authentication may include ensuring that the user or communication device 106 has permission or authorization to use the requested resources, ensuring that the user or communication device 106 has a subscriber account with all necessary service providers, etc. Authentication may require a two-way communication to complete.

The resource arbitration server 134 further includes a request receipt device 318. Requests are received, demodulated and decoded if necessary and interpreted. Thus, the request receipt device 318, in conjunction with the first communication interface 308 forms a communication circuit to receive a resource use request from the communication device 106. Interpretation may involve determining the nature of the resources required to satisfy the request, checking necessary authorization, and so forth. In one embodiment, a received request is converted to a format that can be compared with resource service content data reported by resource management devices. For example, a user request for “high-quality motion picture stream data” might be converted to “resource for transmitting MPEG4-format motion picture data at 20 or more frames per second.”

The resource arbitration server 134 further includes a resource availability checking device 320. After a resource use request has been received and interpreted, the resource availability checking device 320 locates within the network available resources satisfying conditions of the resource use request. The network here refers to the network 102 associated with the resource arbitration server 134 (FIG. 1). Other network resources may be checked as well. Conditions of the resource request requiring satisfaction may include quantity of resources, current or scheduled availability of resources, cost of resources, and so forth. Preferably, conditions such as these are included in the resource use request and are interpreted in the request receipt device 318.

The resource availability checking device 320 receives and stores information about the availability of resources on the network. The resource availability checking device 320 may issue inquiries to the network or to components of the network such as the resource management device 130 (FIG. 1) to identify the available resources. The network may keep a database or other store of information about available resources that may be accessed by the resource availability checking device 320. The information may be provided currently or may be retrieved from storage at the resource availability checking device 320 or at another location. If resources are available matching the requested conditions, the resource availability checking device 320 will reserve resources to attempt to satisfy the request.

In another embodiment, the resource availability checking device 320 determines the availability of resources and stores that information in a database such as the memory 306. When a resource use request is received from a user, the resource availability checking device 320 queries the database to provide availability data in response to the request. Further, the resource availability checking device 320 queries the resource management device upon each such occurrence to provide availability data in response to the request.

In yet another embodiment, the resource availability checking device 320 determines a portion of the resource availability data in advance and stores the results in the resource arbitration server's database. When a user requests use of a resource, the resource availability checking device 320 determines availability by querying resource management devices for only the remainder of the necessary data based on the data stored in the database.

Resource availability, or determining whether it is possible to use a resource for the purposes of the user, is determined by whether the resource specifications and status match the requirements of the user's request. Resources specifications include such information as the content and nature of the service provided, conditions for use, address within the network, and so forth. Resource status can be open or available, busy or unavailable, available only until a scheduled time or unavailable until a scheduled time. This mode can be considered a mode wherein the specifications are entered in the database of the resource arbitration server and a check for open status is performed, based on network addresses stored in the database, for only those resources whose specifications match the conditions of the user's request.

The resource arbitration server 134 further includes a resource reservation device 322. The resource reservation device 322, according to resource availability informed by resource availability checking device 320, sends resource reservation request with the user's authentication information to resource managing devices of available resources that satisfy the resource request, that is, those resources which are validated. The resource reservation device 322 further compiles reservation results sent in by the resource management devices for each reserved resource and compares or checks the results against user resource requests. The resource reservation device 322 further determines, if there are insufficient resources and if so, re-checks the available resources within the network.

The resource arbitration server 134 further includes a resource confirmation device 324. The resource confirmation device 324 collects resource reservation results. Where there are resources satisfying the resource request, the resource confirmation device 324 provides notification to the user at the communication device 106 as to the method for confirming a resource reservation along with the reservation results. The resource confirmation device 324 also receives notification of confirmation and cancellation of resource reservation results and forwards such notification to appropriate resource managing devices.

The resource arbitration server 134 further includes an end of usage reporting device 326. The end of usage reporting device 326 receives from users a notification of the end of usage of resources and notifies each resource of the end of usage thereof. In some embodiments and for the use of some particular resources, the reporting of the end of usage of the resources may be omitted as unnecessary. For example, where the required resource is a World Wide Web page, notification of the end of access to such a page is generally not required. However, it may be useful to record or otherwise track the end of usage of resources for purposes of performance monitoring and optimization and for billing the user.

The resource arbitration server 134 further includes a device for calculating resource use fees 328 and a device for requesting payment of resource use fees 330. Preferably, the usage fees are calculated based on the record of use of each resource. In one embodiment, the device for calculating fees 328 monitors in the resource arbitration server 134 the resource usage status of each of the resources used in user tasks. The device further compares usage status monitor results with usage status reported by resource management devices and notifies the resource management device of the usage status check when the compared data fail to match. A usage fee is calculated when the compared data match.

The request for payment is preferably sent to the communication device 106 and payment arrangements are preferably handled automatically, without user intervention. In one embodiment, the device for requesting payment of resource use fees 330 includes a device for deducting the usage fee from an amount paid in advance by a user, a device for charging the usage fee to a credit card account provided in advance by a user, or a means for combining charges for resource arbitration server usage fees and resource usage fees.

In one embodiment illustrated in FIGS. 1 and 3, the resource arbitration server 134 is physically a part of the network 102 with which it is associated. In an alternative embodiment, the resource arbitration server 134 does not physically exist within the system. Rather, processes performed by the resource arbitration server are instead performed for each resource by a resource management device such as resource management device 130 (FIG. 1). In another alternative embodiment, the resource arbitration servers exist separately from the resource management devices for the various devices and all communication with users is performed by the resource arbitration servers. In still another alternative embodiment, the resource arbitration servers exist separately from the resource management devices for the various devices and processes to be performed by the resource arbitration servers and resource management devices are allocated therebetween through negotiations with resource providers.

Another embodiment tries to accommodate users who do not know how to communicate with the resource arbitration servers. For example, the users may not know the Internet Protocol (IP) address assigned to the desired resource arbitration server. For such users, a query message may be broadcast over the network in order for a resource arbitration server to notify users as to the method of communicating with a resource arbitration server when it receives the query.

Another embodiment tries to accommodate the need to track and charge for usage of resources. In this embodiment, users use resource arbitration servers, for which they have concluded a contract for resource arbitration services on behalf of the user in advance, to track and charge for usage of resources. Verification of such a contract can be part of the user authentication process.

FIG. 4 is a block diagram of a resource management device 130 of the communication system 100 of FIG. 1. The resource management device 130 is shown in conjunction with a network 102 and resources 116, 118.

The resource management device 130 includes a control device 402 and a memory 404. The control device 402 controls the operation of the resource management device 130. In a typical embodiment, the control device 402 includes a processor operable in response to data and instructions stored in the memory 404. The other elements of the resource management device 130 are shown in FIG. 4 as functional or operational blocks. These blocks may be implemented as hardware or software or as combinations of the two. For example, the functional blocks may be implemented as software instructions running on the processor of the control device 402.

The resource management device 130 includes a content reporting device 406 which determines the content or nature of the service provided by the resources 116, 118 and reports this information within the network 102. The resource management device 130 further includes a device to monitor usage status 408 as well as a device 409 to compare usage status The resource management device 130 further includes a device 410 for receiving and interpreting requests to check availability of resources. The requests are received from other locations in the network, such as a resource arbitration server (FIG. 1). The resource management device 130 also includes an associated device 412 to check and report resource availability.

In one embodiment, the device 410 checks availability of resources based on usage status and reservation status data and reports the results of the checks within the network 102. Once an availability check finds a match for the conditions of a resource request, that resource will then be exempted from any resource availability checks performed in response to subsequent requests for resource availability checks until a resource reservation or reservation cancellation request is received from the communication device that issued resource request and/or the resource arbitrary server that issued the resource availability check request that resulted in a match.

In another embodiment, the device 410 checks availability of resources based on usage status and reservation status data. The device 410 reports the result of the checks within the network 102. For requests for resource availability checks received within a given time segment and for which a requested service is found to be available, notification that the service is available will be issued in response to that request offering the highest resource usage fee. That resource will then be exempted from any resource availability checks performed in response to subsequent requests for resource availability checks until a resource reservation or reservation cancellation request is received from the communication device that issued resource request and/or the resource arbitrary server that issued the resource availability check request. That is, the resource is provisionally reserved for the user submitting the highest bid during the prescribed time segment and the provisional reservation is honored until the reservation is confirmed or cancelled by the user. Preferably, during the specified time segment, users submitting requests for resource availability checks received within the specified time segment, and for which a requested service is available, will be notified of the highest usage fee offer received up to that point in time and requests for resource availability checks will again be accepted. This may be deemed to be an auction mode of operation.

The resource management device 130 further includes a device for managing reservations 414. Preferably, reservations are managed based on the content or nature of a service available from a resource, the quantity of the service to be used, the time of use and other information. The resource management device 130 further includes a device for accepting resource reservations 416 and a device 418 for reserving selected resources in response to a reservation from a user.

The resource management device 130 further includes a device 420 which verifies the identity or other information of individuals attempting to reserve use of selected resources. The device 420 generates authentication data for reserving individuals. The authentication data is provided to a device 422 which reports within the network reservation results and authentication data for reserving individuals.

To handle reservation cancellations, the resource management device 130 includes a device 426 which receives and interprets resource reservation cancellation requests. In response to a cancellation request, a resource reservation cancellation process 428 is activated to cancel reservations based on the resource reservation cancellation requests.

Further, the resource management device 130 includes a device 430 which receives and interprets a resource use request based on advance notification by a user of the reservation confirmation method. After the validity of the resource use request has been confirmed, another device 432 makes the requested resource available. The device 409 compares the content of the user's reservation with the actual use status of the requested resource.

Still further, the resource management device 130 includes a device 436 which receives notification of the end of usage of a resource. Another device 438 ends provision of the resource based on the notification, the content of the user's reservation and the actual use status of the resource.

The resource management device 130 also includes a device 440 for calculating fees based on reservation content and the actual record of use. Another device 442 provides notification to the user as to usage results and fees. The usage results may be a record of use of the selected resources.

From the foregoing, it can be seen the present embodiments provide a communication system and method for resource location and utilization, even for resources which are not network appliances. A resource arbitration server receives requests for resources and locates the requested resources, if available, possibly from more than one network. At the network, a resource management device tracks resource availability and reservations for resource use. In this manner, a wide variety of resources, including land, buildings, non-networked equipment, even legal rights in copyrighted or trade secret material, for example.

While a particular embodiment of the present invention has been shown and described, modifications may be made. It is therefore intended in the appended claims to cover all such changes and modifications which fall within the true spirit and scope of the invention.

1. A communication system comprising:
one or more independent communication networks, each network including:
one or more resource management devices,
resources managed by the resource management device, and
one or more resource arbitration servers; and
a communication device adapted for communication on each of the one or more communication networks.

2. The communication system of claim 1 wherein the communication device further comprises:
a resource use requesting device; and
a communication circuit for communicating a resource use request from the resource requesting device to a resource arbitration server of a communication network.

3. The communication system of claim 2 wherein the communication device further comprises:
a control circuit coupled with the communication circuit and configured to interpret reports of resource reservation results received by the communication circuit from the resource arbitration server in response to the resource use request.

4. The communication system of claim 3 wherein the communication device further comprises:
a selection device configured to select resources for use based on a received report of resource reservation results,
the communication circuit being configured to communicate at least one of a reservation of resources selected for use and a cancellation of resources selected for non-use to the resource arbitration server.

5. The communication system of claim 4 wherein the control circuit is further configured to initiate a notification of end of usage of the resources for use for communication by the communication circuit to the resource arbitration server.

6. The communication system of claim 4 wherein the communication device further comprises:
a task execution circuit which generates a resource reservation confirmation for communication to the resource arbitration server by the communication circuit upon usage of the resources for use.

7. The communication system of claim 4 wherein the communication circuit is further configured to receive a report recording usage of the resources selected for use:

8. The communication system of claim 7 wherein the communication circuit is further configured to receive a request of payment for usage fees for the usage of the resources selected for use:

9. The communication system of claim 1 wherein the communication circuit comprises a radio receiver and a radio transmitter.

10. The communication system of claim 1 wherein the communication circuit comprises a network access card.

11. The communication system of claim 1 wherein each resource arbitration servers of the one or more resource arbitration servers comprises:
a communication circuit to receive a resource use request from the communication device.

12. The communication system of claim 11 wherein each resource arbitration servers of the one or more resource arbitration servers comprises:
an authentication device for authenticating a user associated with the resource use request.

13. The communication system of claim 11 wherein each resource arbitration servers of the one or more resource arbitration servers comprises:
a resource location device which locates within the network associated with the each resource arbitration server available resources satisfying conditions of the resource use request.

14. The communication system of claim 11 wherein each resource arbitration servers of the one or more resource arbitration servers comprises:
a resource reservation device which sends to a resource management device a resource reservation.

15. The communication system of claim 14 wherein the resource reservation device is further configured to send user authentication data to the resource management device.

16. The communication system of claim 14 wherein the resource reservation device is further configured to compile reservation results from the resource management device and to validate the reservation results against received the resource use request.

17. The communication system of claim 16 wherein the resource reservation device is further configured to reserve resources in response to validating the reservation results.

18. The communication system of claim 16 wherein the resource reservation device is further configured to provide a notification to communication device when there are resources satisfying the received resource use request.

19. The communication system of claim 11 wherein each resource arbitration servers of the one or more resource arbitration servers comprises:
a resource cancellation device which receives from the communication device a notification of end of usage of selected resources and notifies the selected resources of the end of the notification of end of usage.

20. The communication system of claim 11 wherein each resource arbitration servers of the one or more resource arbitration servers comprises:
an accounting device which calculates a resource usage fee based on a record of use of each resource.

21. The communication device of claim 20 wherein the accounting device is configured to request payment of the resource usage fee from a user of the communication device.

22. The communication system of claim 1 wherein each resource management device of the one or more management devices comprises:
a control device configured to determine the nature of service provided by the resources managed by the each resource management device and provide a report within a network associated with the each resource management device.

23. The communication system of claim 1 wherein each resource management device of the one or more management devices comprises:
a communication device configured to receive and interpret requests to check availability of resources.

24. The communication system of claim 1 wherein each resource management device of the one or more management devices comprises:
a reservation management device which manages resource reservations based on at least one of nature of a service provided by the resource, quantity of a service requested, requested time of use of the service, and user information associated with the requestor.

25. The communication system of claim 24 wherein the reservation management device is further configured to accept resource reservations for selected resources and reserve the selected resources.

26. The communication system of claim 25 wherein the reservation management device is further configured to report reservation results within the network associated with the resource management device.

27. The communication system of claim 25 wherein the reservation management device is further configured to comparing content of a resource reservation for a resource with actual use status for the resource.

28. The communication system of claim 27 wherein the reservation management device is further configured to receive and interpret resource reservation cancellation requests.

29. The communication system of claim 28 wherein the resource management device is configured to cancel a resource reservation in response to a reservation cancellation request.

30. The communication system of claim 28 wherein the resource management device is configured to 24 end provision of a resource's service in response to one of a notification by a user that use of the resource has ended, contents of a resource reservation and actual use status of the resource.

31. The communication system of claim 1 wherein each resource management device of the one or more management devices comprises:
an authentication device which verifies individuals attempting to reserve use of the resources managed by the resource management device.

32. A communication device operable in conjunction with one or more communication networks, each communication network including resources accessible by the communication device, a resource management device and a resource arbitration server, the communication device comprising:
a resource use requesting device;
a communication circuit for communicating a resource use request from the resource requesting device to a resource arbitration server of a communication network; and
a control circuit coupled with the communication circuit and configured to interpret reports of resource reservation results received by the communication circuit from the resource arbitration server in response to the resource use request.

33. The communication device of claim 32 wherein the communication circuit comprises a radio receiver and a radio transmitter.

34. The communication device of claim 32 wherein the communication circuit comprises a network access card.
